(19) United States
(12) Patent Application Publication
(10) Pub. No.: US 2026/0226772 A1
(43) Pub. Date: Aug. 6, 2026

(54) DOOR LOCK APPARATUS AND VEHICLE

(71) Applicant: BYD COMPANY LIMITED, Shenzhen (CN)

(72) Inventors: Feixiang DING, Shenzhen (CN); Xuebo GUO, Shenzhen (CN); Xijing GONG, Shenzhen (CN); Qinhan WANG, Shenzhen (CN); Limin REN, Shenzhen (CN)

(73) Assignee: BYD COMPANY LIMITED, Shenzhen (CN)

(21) Appl. No.: 19/576,692

(22) Filed: Mar. 24, 2026

Related U.S. Application Data
(63) Continuation of application No. PCT/CN2024/079178, filed on Feb. 29, 2024.

(30) Foreign Application Priority Data
Sep. 26, 2023 (CN) 202322656562.9

(51) Int. Cl. E05B 81/16; E05B 81/06; E05B 81/30

(52) U.S. Cl. CPC E05B 81/16; E05B 81/06; E05B 81/30

(57) ABSTRACT

A door lock apparatus includes a first rocker arm, a second rocker arm, a locking pin, and a locking link. The locking pin is disposed between the first rocker arm and the second rocker arm. Two opposite ends of the locking pin respectively penetrate through the first and the second rocker arms. The locking link abuts against the second rocker arm. The locking link is provided with an unlocking position and a locking position. The first rocker arm has a drive groove. When the locking pin penetrates through the drive groove, the first rocker arm drives, through the locking pin, the second rocker arm to rotate. The locking link switches from the locking position to the unlocking position when the second rocker arm moves. When the locking pin is detached from the drive groove, the locking link remains in the locking position when the first rocker arm moves.

### CROSS-REFERENCE TO RELATED APPLICATIONS

This application claims the benefit of International Application No. PCT/CN2024/079178, filed on Feb. 29, 2024, which claims priority to Chinese Patent Application No. 202322656562.9, filed on Sep. 26, 2023. The disclosures of the prior applications are incorporated herein by reference in their entirety.

### TECHNICAL FIELD

This application relates to the technical field of vehicle accessories, and in particular, to a door lock apparatus and a vehicle.

### BACKGROUND

With the development of the economy and technological advancements, vehicles have become an indispensable transportation tool for people, and door lock apparatuses of the vehicles have become increasingly mature. With the rapid and diversified development of the current automotive industry, users have raised a higher requirement for function diversification and reliability of automotive door locks.

In related technologies, door lock apparatuses may have limited anti-theft capabilities. After a central locking system is engaged, unauthorized access may still occur by reaching through a broken window to actuate an inward-opening handle, thereby opening the door.

### SUMMARY

According to a first aspect, this application provides a door lock apparatus. The door lock apparatus includes a first rocker arm, a second rocker arm, a locking pin, and a locking link. The locking pin is disposed between the first rocker arm and the second rocker arm, two opposite ends of the locking pin respectively penetrate through the first rocker arm and the second rocker arm, and the locking pin is operable to move relative to the first rocker arm and the second rocker arm. The locking link abuts against the second rocker arm, and the locking link is provided with an unlocking position and a locking position. The first rocker arm is provided with a drive groove. When the locking pin penetrates through the drive groove, the first rocker arm is operable to drive, through the locking pin, the second rocker arm to rotate. The locking link is operable to switch from the locking position to the unlocking position when the second rocker arm moves. When the locking pin is detached from the drive groove, the locking link is operable to remain in the locking position when the first rocker arm moves.

In some embodiments, the second rocker arm is provided with a waist-shaped hole, the waist-shaped hole runs through the second rocker arm, one end of the locking pin penetrates through the waist-shaped hole, and the locking pin is operable to move along a long axis of the waist-shaped hole, so that the other end of the locking pin moves to the drive groove, or the locking pin is detached from the drive groove.

In some embodiments, the door lock apparatus further includes a first drive assembly, and the first drive assembly is configured to drive the locking pin to move to the drive groove, or drive the locking pin to detach from the drive groove.

In some embodiments, the first drive assembly includes a first drive member, a first transmission member, and a lock body slider. The first transmission member is rotatably connected between the first drive member and the lock body slider, and the lock body slider is operable to slide relative to the locking pin. The first drive member is operable to drive the first transmission member to rotate, rotation of the first transmission member is operable to drive the lock body slider to move, and the lock body slider is operable to drive the locking pin to move to the drive groove, or drive the locking pin to detach from the drive groove.

In some embodiments, the door lock apparatus further includes an unlocking link. The unlocking link is rotatably connected to the lock body slider, and the locking link abuts against the unlocking link. When the locking link switches from the locking position to the unlocking position, the unlocking link drives the lock body slider to move, and the lock body slider drives the locking pin to penetrate through the drive groove.

In some embodiments, the door lock apparatus further includes a rotating structure and a transmission arm. The rotating structure is configured to connect to a mechanical key, the rotating structure is rotatably connected to the transmission arm, the transmission arm is rotatably connected to the locking link, the rotating structure is operable to be driven by the mechanical key to rotate, and the rotating structure drives the transmission arm to rotate, so that the transmission arm drives the locking link to rotate from the locking position to the unlocking position.

In some embodiments, the door lock apparatus further includes a second drive assembly, and the second drive assembly is configured to drive the locking link to switch between the unlocking position and the locking position.

In some embodiments, the second drive assembly further includes a second drive member and a second transmission member. The second drive member is rotatably connected to the second transmission member, the second transmission member is fixedly connected to the locking link, and the second drive member is operable to drive the second transmission member and the locking link to rotate together, so that the locking link switches between the unlocking position and the locking position.

In some embodiments, both the first rocker arm and the second rocker arm are rotatably connected to the locking pin.

In some embodiments, the door lock apparatus further includes an inward-opening rocker. The inward-opening rocker abuts against the first rocker arm, the inward-opening rocker is configured to connect to an inward-opening handle of a vehicle, the inward-opening handle drives the inward-opening rocker to rotate, and the inward-opening rocker drives the first rocker arm to rotate.

According to a second aspect, this application further provides a vehicle. The vehicle includes a door and the door lock apparatus according to any one of the implementations of the first aspect, and the door lock apparatus is mounted on the door.

In the door lock apparatus provided in this application, when the locking pin penetrates through the drive groove, the first rocker arm is operable to drive, through the locking pin, the second rocker arm to rotate, the locking link is operable to switch from the locking position to the unlocking position when the second rocker arm moves, and the door can be opened by driving an inner door handle (inward-opening handle) or an outer door handle (outward-opening handle). When the locking pin is detached from the drive groove, the locking link is operable to remain in the locking position when the first rocker arm moves, and the door cannot be opened by driving the inner door handle or the outer door handle. Therefore, the door lock apparatus has strong anti-theft and protection performance.

### BRIEF DESCRIPTION OF DRAWINGS

To describe the technical solutions in the embodiments of this application more clearly, the following briefly describes the accompanying drawings needed for use in the implementations. The accompanying drawings in the following descriptions show some implementations of this application, and a person of ordinary skill in the art can still derive other accompanying drawings from these accompanying drawings without creative efforts.

FIG. 1 is a schematic diagram of a structure of a door lock apparatus according to an embodiment of this application;

FIG. 2 is a schematic diagram of a structure of the door lock apparatus in FIG. 1 in another state;

FIG. 3 is an exploded schematic diagram of a three-dimensional structure of the door lock apparatus in FIG. 1; and

FIG. 4 is an exploded schematic diagram of a three-dimensional structure of a door lock apparatus according to an embodiment of this application.

### REFERENCE NUMERALS

100—door lock apparatus; 11—link structure; 12—push rod; 13—outward-opening rocker; 14—cooperating rocker arm; 15—inward-opening rocker; 21—first rocker arm; 213—drive groove; 22—second rocker arm; 221—waist-shaped hole; 23—locking pin; 231—first penetrating portion; 232—second penetrating portion; 233—connecting portion; 24—locking link; 241—first link; 242—second link; 240—connecting groove; 243—driven end; 30—first drive assembly; 31—first drive member; 311—first motor; 312—first worm; 32—first transmission member; 321—first rack portion; 33—lock body slider; 331—limiting rib; 332—sliding groove; 50—second drive assembly; 51—second drive member; 511—second motor; 512—second worm; 52—second transmission member; 521—second rack portion; 53—rotating structure; 531—rotating arm; 532—lock cylinder; 54—transmission arm; 541—drive end; 55—unlocking link; 61—first housing body; 62—second housing body; 610—limiting groove; 611—first connecting shaft; 612—second connecting shaft; 613—third connecting shaft; 614—fourth connecting shaft; 615—fifth connecting shaft; 616—sixth connecting shaft; 617—mounting hole; 618—first fastening groove; and 619—second fastening groove.

### DESCRIPTION OF EMBODIMENTS

The following describes the technical solutions in implementations of this application with reference to the accompanying drawings in the implementations of this application. Clearly, the described implementations are merely some rather than all of the implementations of this application. Based on the implementations in this application, all other implementations obtained by a person of ordinary skill in the art without creative efforts shall fall within the protection scope of this application.

It should be noted that when an assembly is referred to as being “fastened to” another assembly, the assembly may be directly on another assembly or there may be an intermediate assembly. When an assembly is considered to be “connected to” another assembly, the assembly may be directly connected to another assembly or there may be an intermediate assembly.

Unless otherwise defined, all technical and scientific terms used in this application have the same meanings as those commonly understood by a person skilled in the art that belongs to this application. The terms used in this specification of this application are merely intended to describe specific embodiments, and are not intended to limit this application. The term “and/or” used in this application includes any and all combinations of one or more related listed items.

Some implementations of this application are described in detail below with reference to the accompanying drawings. In absence of conflicts, the following embodiments and the features in the embodiments may be mutually combined.

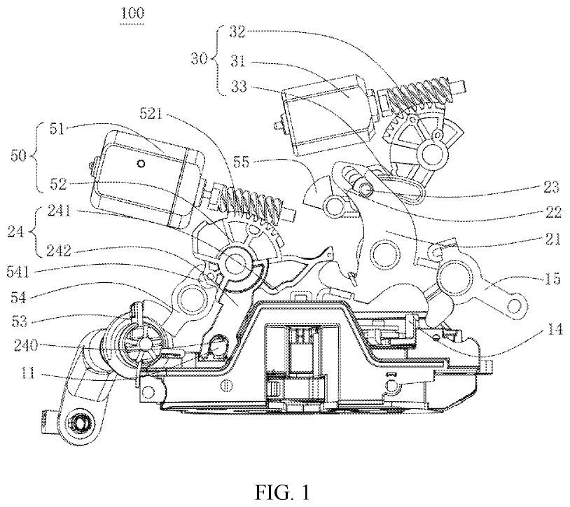

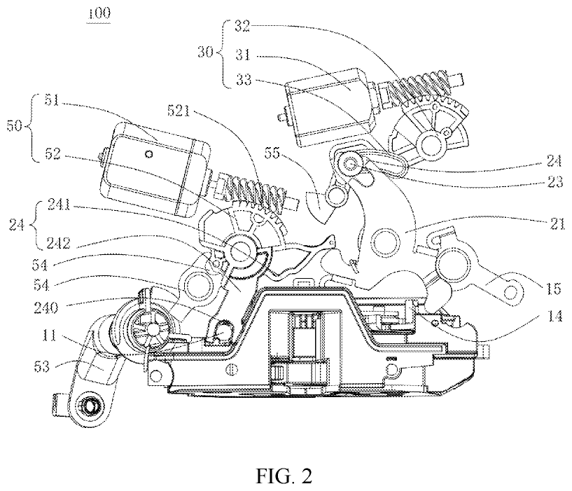

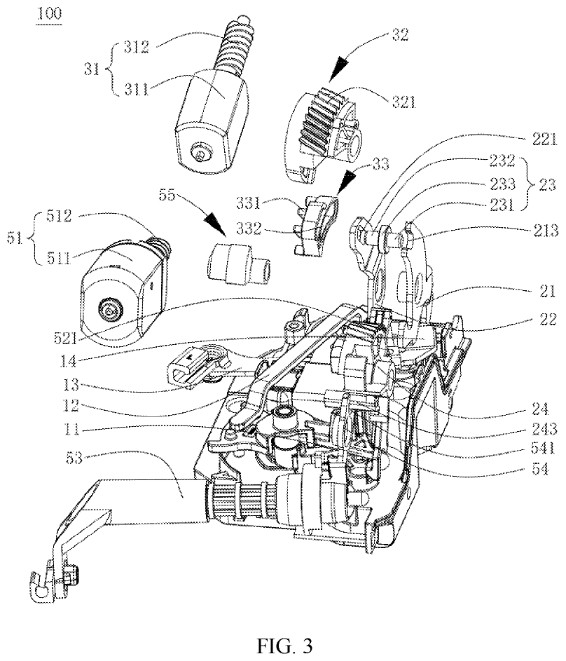

FIG. 1 is a schematic diagram of a structure of a door lock apparatus according to an embodiment of this application. FIG. 2 is a schematic diagram of a structure of the door lock apparatus in FIG. 1 in another state. FIG. 3 is an exploded schematic diagram of a three-dimensional structure of the door lock apparatus in FIG. 1. As shown in FIG. 1 to FIG. 3, this application provides a vehicle. The vehicle includes a door and a door lock apparatus 100. The door lock apparatus 100 is fastened to the door through bolts. The door lock apparatus 100 provided in implementations of this application is applied to the vehicle. The vehicle may be a fuel vehicle or a new energy electric vehicle. The door lock apparatus 100 can implement functions of the vehicle of opening the door and locking the door.

The door lock apparatus 100 includes a link structure 11, a push rod 12, a locking arm, and a lock tongue. The link structure 11 draws the push rod 12, the push rod 12 can abut against the locking arm, and the locking arm can be engaged with the lock tongue. The link structure 11 is provided with an unlocking position and a locking position. A user may drive a second transmission member 52 through a vehicle key, remote control, or the like. The second transmission member 52 abuts against the link structure 11, to drive the link structure 11 to switch to the unlocking position or the locking position. When the link structure 11 switches from the unlocking position to the locking position, the link structure 11 draws the push rod 12 to move, and the push rod 12 is released from abutment with the locking arm. In this case, the door cannot be opened when the user drives an inward-opening handle or an outward-opening handle. When the link structure 11 switches from the locking position to the unlocking position, the link structure 11 draws the push rod 12 to move along a reverse direction, and the push rod 12 abuts against the locking arm. In this case, the door can be opened when the user drives the inward-opening handle or the outward-opening handle.

The door lock apparatus 100 further includes an outward-opening rocker 13 and a cooperating rocker arm 14. The outward-opening rocker 13 is connected to the outward-opening handle of the vehicle, and the outward-opening rocker 13 is connected to the cooperating rocker arm 14 through a pin shaft. When the link structure 11 is in the unlocking position, the user drives the outward-opening handle, the outward-opening handle drives the outward-opening rocker 13 to rotate, the outward-opening rocker 13 drives the cooperating rocker arm 14 to rotate, the cooperating rocker arm 14 drives the push rod 12 to rotate, the push rod 12 drives the locking arm to rotate, and the locking arm is unengaged with the lock tongue, so that the door is opened.

The door lock apparatus 100 further includes an inward-opening rocker 15 and a first rocker arm 21. The inward-opening rocker 15 is connected to the inward-opening handle of the vehicle, the inward-opening rocker 15 abuts against the first rocker arm 21, and the first rocker arm 21 abuts against the cooperating rocker arm 14. When the link structure 11 is in the unlocking position, if the user drives the inward-opening handle, the inward-opening handle drives the inward-opening rocker 15 to rotate, the inward-opening rocker 15 drives the first rocker arm 21 to rotate, the first rocker arm 21 drives the cooperating rocker arm 14 to rotate, the cooperating rocker arm 14 drives the push rod 12 to rotate, the push rod 12 drives the locking arm to rotate, and the locking arm is unengaged with the lock tongue, so that the door is opened.

The door lock apparatus 100 further includes a second rocker arm 22, a locking pin 23, and a locking link 24. The first rocker arm 21 is of a sheet-shaped structure, the second rocker arm 22 is of a sheet-shaped structure, and the first rocker arm 21 and the second rocker arm 22 are disposed opposite to each other at intervals. The locking pin 23 is disposed between the first rocker arm 21 and the second rocker arm 22, two opposite ends of the locking pin 23 respectively penetrate through the first rocker arm 21 and the second rocker arm 22. Both the first rocker arm 21 and the second rocker arm 22 are rotatably connected to the locking pin 23, and the locking pin 23 is operable to move relative to the first rocker arm 21 and the second rocker arm 22. The rotational connection is relative to a fixed connection. That the first rocker arm 21 and the second rocker arm 22 are rotatably connected to the locking pin 23 means the following: The first rocker arm 21 and the second rocker arm 22 are connected through the locking pin 23, and the first rocker arm 21 and the second rocker arm 22 can rotate relative to each other.

The locking pin 23 includes a first penetrating portion 231 and a second penetrating portion 232 that are disposed at the two opposite ends of the locking pin 23, and a connecting portion 233 connected between the first penetrating portion 231 and the second penetrating portion 232. The first penetrating portion 231, the second penetrating portion 232, and the connecting portion 233 are disposed integrally. The connecting portion 233 is sandwiched between the first rocker arm 21 and the second rocker arm 22, the first penetrating portion 231 penetrates through the first rocker arm 21, and the second penetrating portion 232 penetrates through the second rocker arm 22. The first penetrating portion 231, the second penetrating portion 232, and the connecting portion 233 are cylindrical. A radial size of the connecting portion 233 is greater than radial sizes of the first penetrating portion 231 and the second penetrating portion 232. The locking pin 23 can move along a direction perpendicular to thickness directions of the first rocker arm 21 and the second rocker arm 22, and cannot move along the thickness directions of the first rocker arm 21 and the second rocker arm 22. The first rocker arm 21 includes two opposite outer surfaces, and the thickness direction of the first rocker arm 21 refers to a direction perpendicular to the two outer surfaces. The thickness direction of the second rocker arm 22 may be explained by referring to the thickness direction of the first rocker arm 21.

The first rocker arm 21 is provided with a drive groove 213, and an edge of the first rocker arm 21 facing the locking pin 23 is recessed inward to form the drive groove 213. The first penetrating portion 231 of the locking pin 23 penetrates through the drive groove 213, and the first penetrating portion 231 of the locking pin 23 may alternatively be detached from the drive groove 213.

The second rocker arm 22 is provided with a waist-shaped hole 221, and the waist-shaped hole 221 runs through the second rocker arm 22. The second penetrating portion 232 of the locking pin 23 penetrates through the waist-shaped hole 221, and the locking pin 23 is operable to move along a long axis of the waist-shaped hole 221. When the second penetrating portion 232 of the locking pin 23 moves from an upper end of the waist-shaped hole 221 to a lower end of the waist-shaped hole 221, the first penetrating portion 231 of the locking pin 23 moves to the drive groove 213. When the second penetrating portion 232 of the locking pin 23 moves from the lower end of the waist-shaped hole 221 to the upper end of the waist-shaped hole 221, the first penetrating portion 231 of the locking pin 23 is detached from the drive groove 213. The long axis may be explained as follows. For example, a long axis of an ellipse refers to a connection line between two points on the ellipse that are farthest apart from each other. A cross section of the waist-shaped hole 221 in this application is formed through enclosure by two parallel line segments with equal lengths and two circular arcs, and the long axis and the movement of the waist-shaped hole 221 may be explained by referring to the long axis of the ellipse. For example, a direction of a connection line between the upper end and the lower end of the waist-shaped hole, that is, a long axis direction of the waist-shaped hole, is perpendicular to the thickness directions of the first rocker arm and the second rocker arm.

The locking link 24 is provided with a connecting groove 240, and the link structure 11 penetrates through the connecting groove 240. The second rocker arm 22 abuts against the locking link 24, the locking link 24 drives the link structure 11 to rotate, and the link structure 11 switches from the locking position to the unlocking position. The locking link 24 and the link structure 11 switch synchronously between the unlocking position and the locking position. The locking link 24 includes a first link 241 and a second link 242, the first link 241 is fixedly connected to the second link 242, the first link 241 is configured to abut against the second rocker arm 22, and the connecting groove 240 is provided in the second link 242.

As shown in FIG. 1, when the first penetrating portion 231 of the locking pin 23 penetrates through the drive groove 213, the first rocker arm 21 is connected to the second rocker arm 22, the first rocker arm 21 drives, through the locking pin 23, the second rocker arm 22 to rotate, the second rocker arm 22 abuts against the first link 241 of the locking link 24 to rotate, the second link 242 of the locking link 24 drives the link structure 11 to rotate, the locking link 24 and the link structure 11 are in the unlocking position, and the door lock apparatus 100 is in an unlocked state. In this case, the user may drive the inward-opening handle or the outward-opening handle to drive the cooperating rocker arm 14, to open the door.

As shown in FIG. 2, when the locking pin 23 is detached from the drive groove 213, the locking pin 23 and the first rocker arm 21 are released from a fastened state. To be specific, movement of the first rocker arm 21 is relatively independent of movement of the locking pin 23, and the second rocker arm 22 does not rotate when the first rocker arm 21 is driven. The locking link 24 is not driven by an external force, the locking link 24 is in the locking position, and the door lock apparatus 100 is in a locked state. In this case, the door cannot be opened when the user drives the inward-opening handle or the outward-opening handle.

In some embodiments, the door lock apparatus 100 further includes a first drive assembly 30, and the first drive assembly 30 is configured to drive the locking pin 23 to move to the drive groove 213 or to detach from the drive groove 213.

The first drive assembly 30 includes a first drive member 31, a first transmission member 32, and a lock body slider 33. The first transmission member 32 is rotatably connected between the first drive member 31 and the lock body slider 33. The lock body slider 33 is operable to slide relative to the locking pin 23, and the locking pin 23 may penetrate through the lock body slider 33. An output end of the first drive member 31 is rotatably connected to an input end of the first transmission member 32, an output end of the first transmission member 32 is rotatably connected to an input end of the lock body slider 33, and the locking pin 23 penetrates through the lock body slider 33. When the first drive member 31 starts, the first drive member 31 drives the first transmission member 32 to rotate, the first transmission member 32 drives the lock body slider 33 to move, and the lock body slider 33 drives the locking pin 23 to move to the drive groove 213 or to detach from the drive groove 213.

The first drive member 31 includes a first motor 311 and a first worm 312. The first worm 312 penetrates through a rotating shaft of the first motor 311. The first transmission member 32 includes a first rack portion 321. The first rack portion 321 meshes with the first worm 312. The first rack portion 321 is disposed on at least a part of outer peripheral walls of the first transmission member 32. The first rack portion 321 includes a plurality of helical teeth arranged along a circumferential direction, and the plurality of helical teeth mesh with the first worm 312.

The first transmission member 32 is provided with a positioning groove, and the lock body slider 33 is provided with a positioning post, and the positioning post is inserted into the positioning groove, so that the first transmission member 32 is rotatably connected to the lock body slider 33. Certainly, alternatively, the first transmission member 32 may be provided with a positioning post, the lock body slider 33 is provided with a positioning groove, and the positioning post is inserted into the positioning groove, so that the first transmission member 32 is rotatably connected to the lock body slider 33.

A plurality of limiting ribs 331 are disposed on a side of the lock body slider 33 away from the second rocker arm 22, and the plurality of limiting ribs 331 are slidably connected to the door or an external housing body. The limiting ribs 331 are used to limit rotation of the lock body slider 33, and the lock body slider 33 has freedom of movement only along the long axis direction of the waist-shaped hole 221. The lock body slider 33 is provided with a sliding groove 332, and the sliding groove 332 runs through the lock body slider 33. The second penetrating portion 232 of the locking pin 23 may penetrate through the sliding groove 332, and the lock body slider 33 can drive the locking pin 23 to move. Certainly, a same effect is also achieved when the sliding groove 332 is provided on a side of the lock body slider 33 facing the first rocker arm 21, and the sliding groove 332 does not run through the lock body slider 33.

The first worm 312 of the first drive member 31 meshes with the first rack portion 321 of the first transmission member 32, the positioning post of the first transmission member 32 penetrates through the positioning groove of the lock body slider 33, the first transmission member 32 is rotatably connected to the lock body slider 33, and the second penetrating portion 232 of the locking pin 23 penetrates through the sliding groove 332 of the lock body slider 33. When the first motor 311 starts, the first worm 312 rotates, the first worm 312 drives the first rack portion 321 of the first transmission member 32 to rotate, the first transmission member 32 drives the lock body slider 33 to move, and the lock body slider 33 drives the locking pin 23 to move.

In another embodiment, the lock body slider 33 may be omitted, the locking pin 23 is directly clamped in the first transmission member 32, and the first transmission member 32 rotates to directly drive the locking pin 23 to move. The lock body slider 33 and the first transmission member 32 may alternatively be omitted, the first drive member 31 is connected to the locking pin 23, and the first drive member 31 drives the locking pin 23 to move.

In some embodiments, the door lock apparatus 100 further includes a second drive assembly 50, and the second drive assembly 50 is configured to drive the locking link 24 to switch between the unlocking position and the locking position. The second drive assembly 50 further includes a second drive member 51 and a second transmission member 52. The second drive member 51 is rotatably connected to the second transmission member 52, the second transmission member 52 is fixedly connected to the locking link 24, and the second transmission member 52 and the locking link 24 are designed integrally. An output end of the second drive member 51 is rotatably connected to an input end of the second transmission member 52, the second drive member 51 drives the second transmission member 52 and the locking link 24 to rotate together, and the locking link 24 switches between the unlocking position and the locking position.

The second drive member 51 includes a second motor 511 and a second worm 512. The second worm 512 penetrates through a rotating shaft of the second motor 511. The second transmission member 52 includes a second rack portion 521. The second rack portion 521 meshes with the second worm 512. The second rack portion 521 is disposed on at least a part of outer peripheral walls of the second transmission member 52. The second rack portion 521 includes a plurality of helical teeth arranged along a circumferential direction, and the plurality of helical teeth mesh with the second worm 512.

The second motor 511 of the second drive member 51 drives the second worm 512 to rotate, and the second worm 512 drives the second transmission member 52 and the locking link 24 to rotate together. When the second drive member 51 drives the locking link 24 and the second transmission member 52 to rotate clockwise together, the locking link 24 is in the locking position, and the door lock apparatus 100 is in the locked state. When the second drive member 51 drives the locking link 24 and the second transmission member 52 to rotate counterclockwise together, the locking link 24 is in the unlocking position, and the door lock apparatus 100 is in the unlocked state.

In another embodiment, the second transmission member 52 may be omitted, that is, the second drive member 51 directly drives the locking link 24 to rotate.

The door lock apparatus 100 provided in this application may be used as a super locking system and a central locking system of a front vehicle door and/or a rear vehicle door. After leaving the vehicle, the user presses a lock button of a vehicle key for the first time. The lock button can drive the second motor 511 of the second drive member 51 to rotate, the second motor 511 drives the second worm 512 to rotate, and the second worm 512 drives the second transmission member 52 and the locking link 24 to rotate clockwise. In this case, the locking link 24 is in the locking position, the door lock apparatus 100 is in the locked state, and the central locking system is enabled. The user presses the lock button of the vehicle key again. The lock button drives the first motor 311 of the first drive member 31 to rotate, and the first motor 311 drives the first worm 312 to rotate. When the first worm 312 drives the first transmission member 32 to move clockwise, the first transmission member 32 drives the lock body slider 33 to move upward, the lock body slider 33 drives the locking pin 23 to move upward, and the locking pin 23 is detached from the drive groove 213. In this case, the super locking system is enabled. When the super locking system is enabled, the door cannot be opened if the user drives the inward-opening handle or the outward-opening handle.

The user presses an unlock button of the vehicle key. The unlock button drives the first motor 311 of the first drive member 31 to rotate, and the first motor 311 drives the first worm 312 to rotate. When the first worm 312 drives the first transmission member 32 to move counterclockwise, the first transmission member 32 drives the lock body slider 33 to move downward, the lock body slider 33 drives the locking pin 23 to move downward, and the locking pin 23 penetrates through the drive groove 213. In this case, the super locking system is disabled. When the super locking system is disabled, the user drives the inward-opening handle for the first time, to drive the inward-opening rocker 15 to rotate counterclockwise, the inward-opening rocker 15 drives the first rocker arm 21 to rotate clockwise, the first rocker arm 21 drives, through the locking pin 23, the second rocker arm 22 to rotate clockwise, the second rocker arm 22 drives the locking link 24 to rotate counterclockwise, and the locking link 24 switches to the unlocking position. Then, the user drives the inward-opening handle for the second time, the inward-opening handle drives the inward-opening rocker 15 to rotate counterclockwise, the inward-opening rocker 15 abuts against the first rocker arm 21, and the first rocker arm 21 abuts against the cooperating rocker arm 14 to open the door. In addition, the unlock button drives the second motor 511 of the second drive member 51 to rotate, the second motor 511 drives the second worm 512 to rotate, and the second worm 512 drives the second transmission member 52 and the locking link 24 to rotate counterclockwise. In this case, the locking link 24 is in the unlocking position, the door lock apparatus 100 is in the unlocked state, the central locking system is disabled, and the door can be opened by driving either the inward-opening handle or the outward-opening handle.

In a scenario that may occur, after the user enables the central locking system and the super locking system, when the vehicle is powered off, the vehicle key cannot drive the first motor 311 and the second motor 511 to rotate, and cannot open the door of the vehicle. To resolve the foregoing problem, the door of the vehicle needs to be opened by using a mechanical key. The door lock apparatus 100 further includes an unlocking link 55, a rotating structure 53, and a transmission arm 54. The rotating structure 53 is connected to the mechanical key, the mechanical key drives the rotating structure 53 to rotate, the rotating structure 53 is rotatably connected to the transmission arm 54, the transmission arm 54 is rotatably connected to the locking link 24, the locking link 24 abuts against the unlocking link 55, and the unlocking link 55 is rotatably connected to the lock body slider 33.

The rotating structure 53 includes a rotating arm 531 and a lock cylinder 532, and the rotating arm 531 is fixedly sleeved on the lock cylinder 532. A baffle is disposed on an outer wall of the lock cylinder 532, the baffle abuts against the transmission arm 54, and the baffle drives the transmission arm 54 to rotate. The transmission arm 54 includes a drive end 541, the locking link 24 includes a driven end 243, the drive end 541 is of a groove structure, the driven end 243 may be of a columnar structure, and the driven end 243 is accommodated in the drive end 541. When the transmission arm 54 rotates, the drive end 541 drives the driven end 243 to rotate, to implement rotation of the locking link 24. The locking link 24 abuts against the unlocking link 55. The locking link 24 and the unlocking link 55 may be disposed against each other, or may be disposed at intervals. The unlocking link 55 is rotatably connected to the lock body slider 33. The unlocking link 55 is provided with an accommodating groove, the lock body slider 33 is provided with a positioning protrusion, and the positioning protrusion is inserted into the accommodating groove, so that the unlocking link 55 is rotatably connected to the lock body slider 33. In another example, the lock body slider 33 is provided with a positioning protrusion, the unlocking link 55 is provided with an accommodating groove, and the positioning protrusion is inserted into the accommodating groove, so that the unlocking link 55 is rotatably connected to the lock body slider 33.

The user drives the mechanical key to rotate. When the mechanical key abuts against the rotating arm 531, the rotating arm 531 and the lock cylinder 532 rotate counterclockwise together, the baffle of the lock cylinder 532 abuts against the transmission arm 54 to rotate clockwise, and the drive end 541 of the transmission arm 54 drives the locking link 24 to rotate counterclockwise. In this case, the locking link 24 is in the unlocking position, and the central locking system is disabled. Because the locking link 24 abuts against the unlocking link 55, the unlocking link 55 rotates clockwise. The unlocking link 55 drives, through the accommodating groove and the positioning protrusion, the lock body slider 33 to move downward, the lock body slider 33 drives the locking pin 23 to penetrate through the drive groove 213. In this case, the super locking system is disabled. The user can open the door by driving the outward-opening handle or the inward-opening handle.

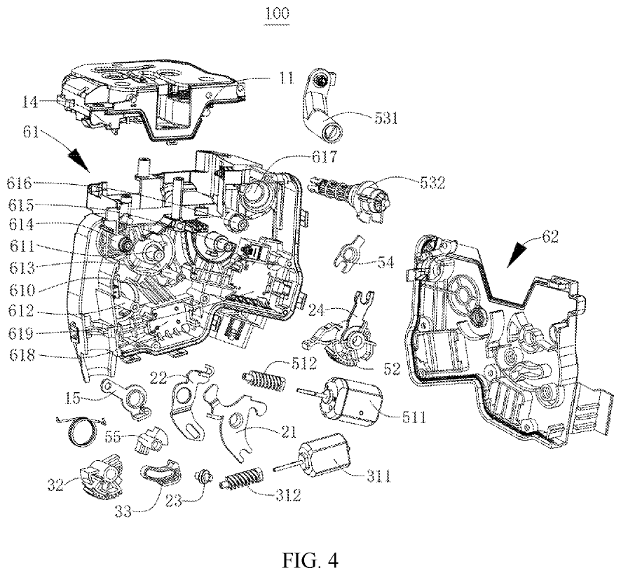

In some embodiments, referring to FIG. 4, the door lock apparatus 100 further includes a housing, and the housing includes a first housing body 61 and a second housing body 62 that can be mated and connected to each other. A first connecting shaft 611 is disposed on an inner wall of the first housing body 61, and the first connecting shaft 611 penetrates through the first rocker arm 21 and the second rocker arm 22, so that the first rocker arm 21 and the second rocker arm 22 can rotate coaxially around the first connecting shaft 611. A second connecting shaft 612 is disposed on the inner wall of the first housing body 61, the second connecting shaft 612 penetrates through the first transmission member 32, and the first transmission member 32 rotates around the second connecting shaft 612. A third connecting shaft 613 is disposed on the inner wall of the first housing body 61, the third connecting shaft 613 penetrates through the unlocking link 55, and the unlocking link 55 rotates around the third connecting shaft 613. A fourth connecting shaft 614 is disposed on the inner wall of the first housing body 61, the fourth connecting shaft 614 penetrates through the inward-opening rocker 15, and the inward-opening rocker 15 rotates around the fourth connecting shaft 614. A fifth connecting shaft 615 is disposed on the inner wall of the first housing body 61, the fifth connecting shaft 615 penetrates through the second transmission member 52, and the second transmission member 52 and the locking link 24 rotate around the fifth connecting shaft 615 together. A sixth connecting shaft 616 is disposed on the inner wall of the first housing body 61, the sixth connecting shaft 616 penetrates through the transmission arm 54, and the transmission arm 54 rotates around the sixth connecting shaft 616. The inner wall of the first housing body 61 is further provided with a mounting hole 617, the rotating structure 53 may fixedly penetrate through the mounting hole 617, and the rotating arm 531 projects from the mounting hole 617, to help direct the rotating arm 531 to be inserted into the lock cylinder 532. The first housing body 61 is further provided with a first fastening groove 618, and the first drive member 31 is accommodated and fastened in the first fastening groove 618. The first housing body 61 is further provided with a second fastening groove 619, and the second drive member 51 is accommodated and fastened in the second fastening groove 619. The inner wall of the first housing body 61 is further provided with a limiting groove 610 corresponding to the limiting rib 331 of the lock body slider 33, and the lock body slider 33 moves upward or downward along the limiting groove 610.

The following describes a complete movement process of the door lock apparatus 100. It should be understood that the vehicle key includes the unlock button and the lock button. The central locking system is enabled when the lock button is pressed for the first time, the super locking system is enabled when the lock button is pressed for the second time, and both the super locking system and the central locking system are disabled when the unlock button is pressed.

A movement process of disabling the central locking system is as follows. The unlock button of the vehicle key is pressed, the unlock button drives the second motor 511 to start, and the second motor 511 drives the second worm 512 to rotate. When the second worm 512 drives the second transmission member 52 and the locking link 24 to move counterclockwise, the locking link 24 drives the link structure 11 to move rightward. In this case, the locking link 24 is in the unlocking position, the door lock apparatus 100 is in the unlocked state, and the central locking system is disabled.

When the central locking system is disabled, a movement process of opening the door is as follows. The inward-opening handle drives the inward-opening rocker 15 to rotate counterclockwise, the inward-opening rocker 15 abuts against the first rocker arm 21, the inward-opening rocker 15 drives the first rocker arm 21 to rotate clockwise, and the second rocker arm 22 abuts against the cooperating rocker arm 14 to open the door.

A movement process of enabling the central locking system is as follows. The lock button of the vehicle key is pressed, the lock button drives the second motor 511 to start, and the second motor 511 drives the second worm 512 to rotate. When the second worm 512 drives the second transmission member 52 and the locking link 24 to move clockwise, the locking link 24 is in the locking position, the door lock apparatus 100 is in the locked state, and the central locking system is enabled.

When the central locking system is enabled, a movement process of opening the door is as follows. There are two manners of opening the door. In a first manner, the inward-opening handle is driven for the first time, the inward-opening handle drives the inward-opening rocker 15 to rotate counterclockwise, the inward-opening rocker 15 drives the first rocker arm 21 to rotate clockwise, the first rocker arm 21 drives, through the locking pin 23, the second rocker arm 22 to rotate clockwise, and the second rocker arm 22 drives the locking link 24 to rotate counterclockwise. In this case, the locking link 24 is in the unlocking position, and the door lock apparatus 100 is in the unlocked state. Then, the inward-opening handle is driven for the second time to drive the inward-opening rocker 15 to rotate counterclockwise, the inward-opening rocker 15 abuts against the first rocker arm 21, the inward-opening rocker 15 drives the first rocker arm 21 to rotate counterclockwise, and the first rocker arm 21 abuts against the cooperating rocker arm 14 to open the door. In other words, the door can be opened by pulling the inward-opening handle twice. In a second manner, the unlock button of the vehicle key is pressed to drive the second drive member 51 to rotate reversely, so that the door lock apparatus 100 is in the unlocked state, and the door can be directly opened by driving the inward-opening handle or the outward-opening handle.

A movement process of disabling the super locking system is as follows. The unlock button of the vehicle key is pressed, the unlock button starts the first motor 311, the first motor 311 drives the first worm 312 to rotate, the first worm 312 drives the first transmission member 32 to move counterclockwise, the first transmission member 32 drives the lock body slider 33 to slide downward, the lock body slider 33 drives the locking pin 23 to slide downward, and the locking pin 23 penetrates through the drive groove 213. In this case, the super locking system is disabled.

When the super locking system is disabled, a movement process of opening the door is as follows. The door can be opened by pulling the inward-opening handle twice.

A movement process of enabling the super locking system is as follows. The lock button of the vehicle key is pressed for the second time, the lock button starts the first motor 311, and the first motor 311 drives the first worm 312 to rotate. When the first worm 312 drives the first transmission member 32 to move clockwise, the first transmission member 32 drives the lock body slider 33 to slide upward, the lock body slider 33 drives the locking pin 23 to slide upward, and the locking pin 23 is detached from the drive groove 213. In this case, the central locking system is enabled. When the locking pin 23 is detached from the drive groove 213, movement of the first rocker arm 21 is relatively independent of movement of the second rocker arm 22. The second rocker arm 22 and the locking link 24 are not driven by an external force, and the locking link 24 is still in the locking position. In this way, the door lock apparatus 100 is in the locked state, and the door cannot be opened by driving the inward-opening handle or the outward-opening handle.

When the central locking system and the super locking system are enabled, a movement process of opening the door with the mechanical key is as follows. When the mechanical key abuts against the rotating arm 531, the rotating arm 531 and the lock cylinder 532 rotate counterclockwise together, the baffle of the lock cylinder 532 abuts against the transmission arm 54 to rotate clockwise, and the drive end 541 of the transmission arm 54 drives the locking link 24 to rotate counterclockwise. In this case, the locking link 24 is in the unlocking position, and the central locking system is disabled. Because the locking link 24 abuts against the unlocking link 55, the unlocking link 55 rotates clockwise. The unlocking link 55 drives, through the accommodating groove and the positioning protrusion, the lock body slider 33 to move downward, the lock body slider 33 drives the locking pin 23 to penetrate through the drive groove 213. In this case, the super locking system is disabled. The user can open the door by driving the outward-opening handle or the inward-opening handle.

In the descriptions of the embodiments of this application, it should be noted that the orientations or positional relationships indicated by the terms “center”, “upper”, “lower”, “left”, “right”, “vertical”, “horizontal”, “inner”, “outer”, and the like are orientations or positional relationships based on the accompanying drawings, and are merely used for ease of describing this application and simplifying the descriptions, rather than indicating or implying that an indicated apparatus or element must have a specific orientation or be constructed and operated in a specific orientation, and therefore should not be understood as a limitation on this application.

The foregoing disclosure is merely some embodiments of this application. Certainly, the scope of the claims of this application should not be limited thereto. A person of ordinary skill in the art may understand that all or some of procedures for implementing the foregoing embodiments and equivalent variations made according to the claims of this application shall fall within the scope of this application.

1. A door lock apparatus, comprising:
a first rocker arm;
a second rocker arm;
a locking pin; and
a locking link,
wherein the locking pin is disposed between the first rocker arm and the second rocker arm, two opposite ends of the locking pin respectively penetrate through the first rocker arm and the second rocker arm, and the locking pin is operable to move relative to the first rocker arm and the second rocker arm;
the locking link abuts against the second rocker arm, and the locking link is provided with an unlocking position and a locking position;
the first rocker arm is provided with a drive groove,
wherein when the locking pin penetrates through the drive groove, the first rocker arm is operable to drive, through the locking pin, the second rocker arm to rotate, and the locking link is operable to switch from the locking position to the unlocking position when the second rocker arm moves; and
wherein when the locking pin is detached from the drive groove, the locking link is operable to remain in the locking position when the first rocker arm moves.

2. The door lock apparatus according to claim 1, wherein the second rocker arm is provided with a waist-shaped hole, the waist-shaped hole runs through the second rocker arm, one end of the locking pin penetrates through the waist-shaped hole, and the locking pin is operable to move along a long axis of the waist-shaped hole, so that the other end of the locking pin moves to the drive groove, or the locking pin is detached from the drive groove.

3. The door lock apparatus according to claim 1, the door lock apparatus further comprising a first drive assembly, and the first drive assembly being configured to drive the locking pin to move to the drive groove, or drive the locking pin to detach from the drive groove.

4. The door lock apparatus according to claim 3, wherein the first drive assembly comprises a first drive member, a first transmission member, and a lock body slider, the first transmission member is rotatably connected between the first drive member and the lock body slider, and the lock body slider is operable to slide relative to the locking pin; and the first drive member is operable to drive the first transmission member to rotate, rotation of the first transmission member is operable to drive the lock body slider to move, and the lock body slider is operable to drive the locking pin to move to the drive groove, or drive the locking pin to detach from the drive groove.

5. The door lock apparatus according to claim 4, the door lock apparatus further comprising an unlocking link, the unlocking link being rotatably connected to the lock body slider, and the locking link abutting against the unlocking link; wherein when the locking link switches from the locking position to the unlocking position, the unlocking link drives the lock body slider to move, and the lock body slider drives the locking pin to penetrate through the drive groove.

6. The door lock apparatus according to claim 5, the door lock apparatus further comprising a rotating structure and a transmission arm, the rotating structure being configured to connect to a mechanical key, the rotating structure being rotatably connected to the transmission arm, and the transmission arm being rotatably connected to the locking link, wherein the rotating structure is operable to be driven by the mechanical key to rotate, and the rotating structure drives the transmission arm to rotate, so that the transmission arm drives the locking link to rotate from the locking position to the unlocking position.

7. The door lock apparatus according to claim 1, the door lock apparatus further comprising a second drive assembly, and the second drive assembly being configured to drive the locking link to switch between the unlocking position and the locking position.

8. The door lock apparatus according to claim 7, wherein the second drive assembly further comprises a second drive member and a second transmission member, the second drive member is rotatably connected to the second transmission member, the second transmission member is fixedly connected to the locking link, and the second drive member is operable to drive the second transmission member and the locking link to rotate together, so that the locking link switches between the unlocking position and the locking position.

9. The door lock apparatus according to claim 1, wherein both the first rocker arm and the second rocker arm are rotatably connected to the locking pin.

10. The door lock apparatus according to claim 1, the door lock apparatus further comprising an inward-opening rocker, the inward-opening rocker abutting against the first rocker arm, and the inward-opening rocker being configured to connect to an inward-opening handle of a vehicle, wherein the inward-opening handle drives the inward-opening rocker to rotate, and the inward-opening rocker drives the first rocker arm to rotate.

11. A vehicle, comprising a door and the door lock apparatus according to claim 1, wherein the door lock apparatus is mounted on the door.
